(19) United States
(12) Patent Application Publication
(10) Pub. No.: US 2023/0089806 A1
(43) Pub. Date: Mar. 23, 2023

(54) COMPOSITIONS AND METHODS FOR MAKING CARBON FIBERS FROM ASPHALTENES

(71) Applicant: Enlighten Innovations Inc., Calgary (CA)

(72) Inventor: Michael Zenaitis, Calgary (CA)

(21) Appl. No.: 17/947,543

(22) Filed: Sep. 19, 2022

Related U.S. Application Data
(60) Provisional application No. 63/245,513, filed on Sep. 17, 2021.

(51) Int. Cl. D01F 9/14; C01B 32/205; C01B 32/23

(52) U.S. Cl. CPC D01F 9/14; C01B 32/205; C01B 32/23

(57) ABSTRACT

The present technology provides fibers containing high levels of asphaltene but low levels of sulfur and total metals, starting from highly asphaltenic feeds with significant levels of sulfur and total metals. Thus, the present technology provides fibers comprising at least 30 wt % asphaltenes, less than 1 wt % sulfur and less than 0.1 wt % of total metals based on the weight of the fiber. Further, methods of making such asphaltenic fibers are provided, as well as methods of preparing carbon fibers therefrom.

### CROSS REFERENCE TO RELATED APPLICATIONS

This application claims priority to U.S. Provisional Application No. 63/245,513, filed Sep. 17, 2021, which is incorporated by reference in its entirety.

### FIELD OF THE TECHNOLOGY

The present technology relates to compositions and methods for making carbon fibers from asphaltenes. In particular, the present technology relates to intermediate fibers containing high amounts of asphaltenes but low amounts of sulfur and metal impurities. The present technology further relates to methods of making such intermediate fibers from high-asphaltene feedstocks with significant sulfur and metal impurities as well as making carbon fibers from the intermediate fibers.

### BRIEF SUMMARY OF THE TECHNOLOGY

The present technology provides fibers containing high levels of asphaltene but low levels of sulfur and total metals. Thus, the present technology provides fibers comprising at least 30 wt % (herein, “wt %” means “weight percent”) asphaltenes, less than 1 wt % sulfur and less than 0.1 wt % or less than 0.05 wt % of total metals based on the weight of the fiber. These asphaltenic fibers may be used to produce high-quality carbon fibers comparable to those made from costly polyacrylonitrile, but with fewer of the defects often found in pitch-based fibers.

The present technology also provided methods of making such asphaltenic fibers, as well as methods of preparing carbon fibers therefrom. The methods include melt-spinning a fiber feedstock into a fiber as disclosed in any embodiment herein, wherein the fiber feedstock comprises at least 30 wt % asphaltenes, a sulfur content of less than 1 wt % and a total metals content of less than 0.1 wt % or less than 0.05 wt %. The methods may further include contacting a hydrocarbon feedstock with an effective amount of sodium metal and an effective amount of exogenous capping agent at a temperature of 250-500° C., to produce a mixture of sodium salts and a converted feedstock, wherein the hydrocarbon feedstock comprises at least 1 wt % asphaltenes, a sulfur content of at least 1 wt % and a total metals content of at least 0.1 wt % or at least 0.05 wt %; and the converted feedstock comprises at least 30 wt % asphaltenes, light hydrocarbons, a sulfur content of less than 1 wt %, and a total metals content of less than 0.1 wt % or less than 0.05 wt %. The methods may further include stabilization by oxidizing the fiber to produce an oxidized fiber. The oxidized fibers may then be carbonized, e.g., by heating the oxidized fiber to 1000° C.-2000° C. in an inert, oxygen-free atmosphere.

The foregoing is a summary of the disclosure and thus by necessity contains simplifications, generalizations, and omissions of detail. Consequently, those skilled in the art will appreciate that the summary is illustrative only and is not intended to be in any way limiting. Other aspects, features, and advantages of the processes described herein, as defined by the claims, will become apparent in the detailed description set forth herein and taken in conjunction with the accompanying drawings.

### DETAILED DESCRIPTION OF THE TECHNOLOGY

The following terms are used throughout as defined below.

As used herein, singular articles such as “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

As used herein, “asphaltenes” refers to the constituents of oil that are insoluble in n-pentane or another hydrocarbon as indicated. Asphaltenes may include polyaromatic molecules that comprise one or more heteroatoms selected from S, N, and O. Asphaltenes may also include other sulfur species, e.g., thiols, sulfates, thiophenes, including benzothiophenes, hydrogen sulfide and other sulfides.

In fibers and methods of the present technology, the “asphaltene content” refers to the total amount of asphaltenes in a feedstock measured as the n-pentane insoluble fraction of the feedstock. However, in some aspects and embodiments of the present processes, the asphaltene content may be measured as the insoluble fraction of the hydrocarbon feedstock precipitated or otherwise separated from the feedstock, after mixing with a sufficient quantity of one or more C₃₋₈ alkanes. The C₃₋₈ alkanes may be propane, butane, pentane, hexane, heptane, octane, isomers thereof, or mixtures of any two or more thereof. Thus, in some embodiments, the asphaltene content of a fiber or feed may be defined as the constituents insoluble in heptane. By “sufficient quantity,” is meant an amount beyond which no further precipitation/separation of insoluble fractions from the hydrocarbon feedstock is observed. A detailed discussion of the physical properties and structure of asphaltenes and the process conditions (temperatures, pressures, solvent/oil ratios) required to produce a specific asphaltene is described in J. G. Speight, “Petroleum Asphaltenes Part 1: Asphaltenes, Resins and the Structure of Petroleum”, Oil & Gas Science and Technology—Rev IFP, Vol 59 (2004) pp. 467-477 (incorporated herein by reference in its entirety and for all purposes). The standard test method for determining heptane (C7) insoluble asphaltene content is described by ASTM standard D6560-17 and can be extended to any alkane, including pentane.

As used herein, “hydrocarbon feedstocks” refers to any material that may be an input for refining, conversion or other industrial process in which hydrocarbons are the principal constituents. Hydrocarbon feedstocks may be solid or liquid at room temperature and may include non-hydrocarbon constituents such as heteroatom-containing (e.g., S, N, O, P, metals) organic and inorganic materials. Crude oils, refinery streams, chemical plant streams (e.g. steam cracked tar) and recycling plant streams (e.g., lube oils and pyrolysis oil from tires or municipal solid waste) are non-limiting examples of hydrocarbon feedstocks.

The present technology provides cost-effective fiber compositions that serve as intermediates (e.g., prior to stabilization and/or carbonization) in carbon fiber production and processes for preparing carbon fibers from asphaltenes via such intermediates. While the fiber compositions are high in asphaltenes, they contain lower levels of detrimental impurities such as sulfur and metals than current asphaltene-containing fibers. Thus, in a first aspect, the present technology provides a fiber including at least 30 wt % asphaltenes, less than 1 wt % sulfur and less than 0.1 wt % or less than 0.05% total metals based on the weight of the fiber. For example, the fiber may include 30 wt % to 100 wt % asphaltenes, such as 30 wt %, 35 wt %, 40 wt %, 45 wt %, 50 wt %, 55 wt %, 60 wt %, 65 wt %, 70 wt %, 75 wt %, 80 wt %, 85 wt %, 90 wt %, 95 wt %, 97 wt %, 99 wt % or 100 wt % asphaltenes or an amount between and including any two of the foregoing values. In any embodiments, the fiber may include at least 60 wt % asphaltenes, such as 60 wt % to 100 wt %, or 60 wt % to 95 wt %.

Fibers of the present technology may have essentially any length, and may have a diameter of from 1 μm to 20 μm. Thus, the fiber may have a diameter, e.g., of 1, 2, 3, 4, 5, 6, 7, 8, 9, 10, 11, 12, 13, 14, 15, 16, 17, 18, 19, or 20 μm or a range between and including any two of the foregoing values, such as, e.g., a diameter from 2 μm to 16 μm, or from 5 μm to 15 μm, or from 10 μm to 20 μm.

Fibers of the present technology have lower levels of key impurities than fibers typically made from highly contaminated asphaltenes. Thus, even if the asphaltenes have sulfur levels above 1 wt %, above 2 wt % or more, the present fibers have less than 1 wt % sulfur, e.g., less than 0.75 wt % sulfur or less than 0.5 wt % sulfur based on the weight of the fiber. (The amount of sulfur in the fibers is calculated as the percent weight of elemental sulfur present.) In any embodiments, the fibers may have 0.01 wt % sulfur to less than 1 wt % sulfur, to less than 0.75 wt %, to less than 0.5 wt % sulfur, or even to less than 0.3 wt % sulfur. For example, the fibers may have 0.01 wt %, 0.02 wt %, 0.03 wt %, 0.04 wt %, 0.05 wt %, 0.075 wt %, 0.1 wt %, 0.15 wt %, 0.2 wt %, 0.25 wt %, 0.3 wt %, 0.4 wt %, 0.5 wt %, 0.6 wt %, 0.7 wt %, 0.75 wt %, 0.8 wt %, 0.9 wt %, or less than 1 wt % sulfur, or a range between and including any two of the foregoing values such as, e.g., 0.05 wt % to less than 1 wt % sulfur or 0.1 wt % to less than 1 wt % or 0.2 wt % to 0.8 wt %.

Similarly the present fibers have low levels of total metals. Even if the asphaltenes used to make the present fibers have more than 0.05 wt % total metals, more than 0.055 wt % total metals, or more than 0.1 wt % total metals, the fibers may have less than 0.1 wt %, less than 0.09 wt %, less than 0.08 wt %, less than 0.07 wt %, less than 0.6 wt %, less than 0.05% total metals, or even less than 0.04 wt %, less than 0.03 wt %, less than 0.02 wt % or less than 0.01 wt % total metals. In any embodiments the present fibers may have 0.00001 wt % to less than 0.1 wt % or 0.00001 wt % to less than 0.05 wt % total metals, including, e.g., 0.00001 wt %, 0.0001 wt %, 0.001 wt %, 0.01 wt %, 0.015 wt %, 0.02 wt %, 0.025 wt %, 0.03 wt %, 0.04 wt %, 0.05 wt %, 0.06 wt %, 0.07 wt %, 0.08 wt %, 0.09 wt %, or less than 0.1 wt %, or a range between or between and including any two of the foregoing values. For example, the fibers may include 0.001 wt % to less than 0.09 wt % or 0.001 wt % to 0.025 wt % or 0.01 wt % to 0.05 wt % total metals.

The total metals in the present fibers may include at least one metal selected from the group consisting alkali metals, alkali earth metals, transition metals, post transition metals, and metalloids. The metalloids may have having an atomic weight equal to or less than 82. For example, the total metals may include at least one of vanadium, nickel, iron, arsenic, lead, cadmium, copper, zinc, chromium, molybdenum, silicon, calcium, sodium, potassium, aluminum, magnesium, manganese, titanium, or mercury. In any embodiments, the total metals in the fibers include at least vanadium and/or at least nickel.

In another aspect, the present technology provides methods of making the present fibers. The methods include melt-spinning a fiber feedstock into any of the fibers described herein, wherein the fiber feedstock comprises at least 30 wt % asphaltenes, a sulfur content of less than 1 wt % and a total metals content of less than 0.1 wt % or less than 0.05 wt %. The fiber feedstock may include 30 wt % to 100 wt % asphaltenes, such as 30 wt %, 35 wt %, 40 wt %, 45 wt %, 50 wt %, 55 wt %, 60 wt %, 65 wt %, 70 wt %, 75 wt %, 80 wt %, 85 wt %, 90 wt %, 95 wt %, 97 wt %, 99 wt % or 100 wt % asphaltenes or an amount between and including any two of the foregoing values. In any embodiments, the fiber feedstock may include at least 60 wt % asphaltenes, such as 60 wt % to 100 wt %, or 60 wt % to 95 wt %.

The fiber feedstock undergoes melt spinning in melted, i.e., liquid, form by being passed through a spinneret. Embodiments of the present invention contemplate the use of any type of spinneret commonly known and used in the art to form carbon-filaments and/or fibers. Generally, the spinneret includes a nozzle head that receives the liquid-phase fiber feedstock and an extrusion plate. The nozzle head may include a reservoir, chamber, plurality of bores, or similar holding area(s) to receive the liquid-phase asphaltene stream from the pump and/or extruder. The extrusion plate is commonly positioned on an end of the spinneret, opposite where the fiber feedstock stream is received. The extrusion plate generally includes a plurality of openings of various sizes and shapes that correspond to intended sizes and shapes of the produced carbon-based filaments. Alternatively, the extrusion plate may have a single opening. From the nozzle head of the spinneret, the fiber feedstock stream is passed through the plurality of openings of the extrusion plate to form carbon-based filaments. In certain embodiments, the extrusion plate rotates with respect to the nozzle head, such that the carbon-based filaments that protrude from the plurality of openings wind around themselves, creating a wound carbon-based filament comprising multiple individual carbon-based filaments. In additional embodiments of the present technology, the liquid-phase fiber feedstock stream may not be spun, but may simply be extruded through the nozzle head and the one or more openings of the extrusion plate. Thus, the non-rotating extrusion plate may produce carbon-based filaments comprising one or more individual filaments.

Melt spinning may be conducted at an elevated temperature. In any embodiments, the fiber feedstock may be spun at a temperature of not more than 40° C. higher than the softening point of the fiber feedstock as determined by a Mettler method (e.g., ISO 5409-2:2007). Alternatively the fiber feedstock may be spun at a temperature in a range of at least 40° C. at least 45° C., at least 50° C., or at least 55° C. higher than the Mettler softening point of the fiber feedstock so that the degree of orientation of a mesophase region in the obtained carbon fiber becomes high. Further, the degree of orientation of a mesophase region can be increased by increasing the fiber diameter of the carbon fiber. The fiber diameter of the carbon fiber is usually 10-20 arm or less but 13-18 μm may be preferred where increased orientation of the mesophase region is desired. Carbon reaching a temperature for spinning is extruded through a nozzle having, for example, an opening diameter of 0.1 mm, and is stretched to form a carbon fiber. Mesophase is oriented in the direction of fiber axis by stretching, and tends to orient in the direction of fiber axis until the carbon is solidified. Accordingly, if the spinning temperature is low or the fiber diameter is small, the carbon extruded through the nozzle opening is immediately solidified and the time of orienteering in the direction of fiber axis is short Namely, the degree of orientation of the spun carbon fibers in the direction of fiber axis is low. Further, when the fiber diameter is excessively large, carbon fibers having insufficient stretching are formed whereby the degree of orientation in the direction of fiber axis is low. In any embodiments, the fiber feedstock may be spun at a temperature of at least 40° C. higher than the Mettler softening point, and the diameter of carbon fibers up to 20% larger than normal. Accordingly, carbon fibers having a high degree of orientation in the direction of fiber axis can be obtained.

Although the liquid-phase fiber feedstock stream may be heated to temperatures from about 200° C. to about 550° C., it is understood that the fiber feedstock stream may undergo some cooling as it travels through the pump, filter, and spinneret. Depending on the process requirements, if the viscosity of the liquid-phase fiber feedstock stream becomes too high to pass through the spinneret, it may become necessary to apply heat to the pump, filter, and spinneret, so as to maintain the fiber feedstock stream in a liquid-phase for proper processing by the spinneret.

Upon the fiber filaments being formed from the spinneret, embodiments of the present methods may include, subjecting the filaments to an inert gas cross-flow. The inert gas used in the cross-flow may include nitrogen, argon, or the like and is applied to the carbon-based filaments at a temperature between about 200° C. to about 400° C. The inert gas cross-flow assists the evaporation and cooling of the carbon-based filaments as they exit the spinneret, such that the filaments solidify to yield asphaltene-containing fibers. Thereafter, the carbon-based fibers are collected and/or winded on a draw-down device. The draw-down device may include any type of filament and/or fiber collection apparatus that is commonly known in the art however, in certain embodiments, the draw-down device may be a wind-up spool, which is a generally cylindrically-shaped body that rotates, so as to collect and wind-up the carbon-based fibers. In addition to collecting the carbon-based fibers, the draw-down device may apply a tension to the carbon-based fibers as the fibers are collected and wound. The tension may be varied by altering the speed at which the draw-down device collects or winds the carbon-based filaments. The tension may promote the alignment of carbon atoms within the fibers, so as to provide for increased tensile strength of the carbon fiber.

Upon winding the carbon-based fibers, embodiments of the present invention include a step, in which the carbon-based fibers are subject to stabilization in an air atmosphere between about 200° C. to about 400° C. for several hours. The stabilization process oxidizes compounds within the carbon-based fibers to prevent relaxation and chain scissions within the filaments during carbonization. Embodiments of the present invention include a step, in which the stabilized asphaltene-based fibers are carbonized by heating the stabilized carbon-based fibers to a temperature of between about 1000° C. to about 1500° C. in an inert atmosphere such as nitrogen, argon, or the like. Alternatively, the carbonizing step may include heating the oxidized fiber to about 1000° C. to about 2000° C. in an inert, oxygen-free atmosphere. In any embodiments, the methods may further include graphitizing the carbon fiber by heating the carbon fiber above 2000° C. up to about 3000° C. in an oxygen-free atmosphere. Carbonization involves the gradual heating (typically in a furnace) of the asphaltene-based fibers up to about the desired temperature. In one or more embodiments, carbonization may be completed in less than about 24 hours. However, because the liquid-phase fiber feedstock stream used in embodiments of the present methods has such a high carbon content, the carbonization may be completed in significantly less than about 12 hours, and more preferably in less than 3 hours. Although carbonization is typically the most time-consuming and rate-limiting step in conventional carbon fiber manufacturing, the present method of embodiments of the present invention can be carried out much more quickly due to a shorter carbonization dwell time period. During carbonization, non-carbon elements (“impurities”), such as hydrogen, oxygen, nitrogen, and sulfur, are driven from the fiber feedstock, in the form of H₂, O₂, N₂, gaseous RCN, HN, HS compounds, etc., yielding essentially a carbon fiber. However, because the fiber feedstock of the present technology contains much lower levels of such impurities, especially of sulfur and metals, higher quality carbon fibers are obtained than from previous asphaltenic feedstocks. Carbon-carbon bonds form between the fiber feedstock structures and the carbon fiber to form a homogeneous, high-strength monolithic structure. In addition, because the fiber feedstock stream preferably has a low H/C ratio, off-gassing is reduced and the yield rate of carbon fiber (by weight) from the liquid-phase fiber feedstock stream is high.

The methods may further include preparing the fiber feedstock from hydrocarbons having a high asphaltene content as well as high levels of sulfur and/or total metals. Thus the methods may further include contacting a hydrocarbon feedstock with an effective amount of sodium metal and an effective amount of exogenous capping agent at a temperature of 250-500° C., to produce a mixture of sodium salts and a converted feedstock (which in favorable cases, may be used as the fiber feedstock), wherein the hydrocarbon feedstock comprises at least 10 wt % asphaltenes (or at least 20 wt % asphaltenes or at least 30 wt % asphaltenes), a sulfur content of at least 1 wt % and a total metals content of at least 0.1 wt % or at least 0.05 wt %; and the converted feedstock comprises at least 30 wt % asphaltenes, a sulfur content of less than 1 wt %, and a total metals content of less than 0.1 wt % or less than 0.05 wt %.

The hydrocarbon feedstock used in the present methods contains asphaltenes (e.g., 1-100 wt %) and is generally high in asphaltenes and high in sulfur content and total metals. For example, the hydrocarbon feedstock may include 10-100 wt % asphaltenes, such as 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, 85 wt %, 90 wt %, 95 wt %, 97 wt %, 99 wt % or 100 wt % asphaltenes or an amount between and including any two of the foregoing values. Thus, in any embodiments, the hydrocarbon feedstock may include at least 30 wt % asphaltenes, such as 30 wt % to 99 wt % or 100 wt %. In any embodiments, the hydrocarbon feedstock may include at least 60 wt % asphaltenes, such as 60 wt % to 100 wt %, or 60 wt % to 95 wt % or 99 wt %. The sulfur content of the hydrocarbon feedstock may range from 0.5 wt % or 0.75 wt %, or 1 wt % to 10 wt %, e.g., 0.5 wt %, 0.75 wt %, 1 wt %, 1.5 wt %, 2 wt %, 3, wt %, 4 wt %, 5, wt %, 6 wt %, 7 wt %, 8 wt %, 9 wt %, 10 wt %, or a range between and including any two of the foregoing values. For example, the sulfur content of the hydrocarbon feedstock may be 1 w % to 10 wt % or 4 wt % to 9 wt %. In any embodiments of the methods, the total metals content of the hydrocarbon feedstock may be from 0.015 or 0.02 wt % to 1 wt % or alternatively from 0.05 wt % to 1 wt %. For example, the total metals may be 0.015 wt %, 0.02 wt %. 0.03 wt %, 0.04 wt %, 0.05 wt %, 0.06 wt %, 0.07 wt %, 0.08 wt %, 0.09 wt %, 0.1 wt %, 0.2 wt %, 0.3 wt %, 0.4 wt %, 0.5 wt %, 0.6 wt %, 0.7 wt %, 0.8 wt %, 0.9 wt %, 1 wt %, or a range between and including any two of the foregoing values. In any embodiments the total metals content of the hydrocarbon feedstock may be from 0.015 wt % or 0.02 wt % to 0.5 wt % or from 0.02 wt % to 0.6 wt %, or from 0.05 wt % to 0.4 wt %, or from 0.04 wt % to 0.3 wt %.

Hydrocarbon feedstocks for the present processes have the asphaltene and impurities profiles set forth herein. They are or may be derived from virgin crude oils (for example petroleum, heavy oil, bitumen, shale oil, and oil shale). Hydrocarbon feedstocks may also be the undistilled residue left after distillation of a virgin crude oil (also known as, “vacuum residue” or “vac. resid.”) or the asphaltene-containing fraction resulting from a solvent-deasphalting process.

The hydrocarbon feedstock may have a density from 800 to 1200 kg/m³ at 15.6° C. or 60° F. For example, the density may be 800, 825, 850, 875, 900, 925, 975, 1000, 1050, 1100, 1150, or 1200 kg/m³ or a range between and including any two of the foregoing values. Thus, in any embodiments, the density may be, e.g., from 850 to 1200 kg/m³, 900 to 1200 kg/m³, 950 to 1200 kg/m³, or 925 to 1100 kg/m³.

In methods of the present technology, the hydrocarbon feedstock is contacted with an effective amount of sodium metal and an effective amount of exogenous capping agent. Any suitable source of sodium metal may be used, including, but not limited to electrochemically generated sodium metal, e.g., as described in U.S. Pat. No. 8,088,270, incorporated by reference in its entirety herein. The effective amount of sodium in its metallic state and used in the contacting step will vary with the level of heteroatom, metal, and asphaltene impurities of the hydrocarbon and residual feedstocks, the desired extent of conversion or removal of an impurity, the temperature used and other conditions. In any embodiments, stoichiometric or greater than stoichiometric amounts of sodium metal may be used to remove all or nearly all sulfur content, e.g., 1-3 mole equivalents of sodium metal versus sulfur content. In any embodiments, the hydrocarbon feedstock or residual feedstock is contacted with more than 1 mole equivalent of sodium metal versus the sulfur content therein, e.g., 1.1, 1.15, 1.2, 1.25, 1.3, 1.4, 1.5, 2, 2.5 or 3 mole equivalents of sodium metal.

The exogenous capping agent used in the present processes is typically used to cap the radicals formed when sulfur and other heteroatoms have been abstracted by the sodium metal during the contacting step. Although some feedstocks may inherently contain small amounts of naturally occurring capping agents (“endogenous capping agents”), such amounts are insufficient to cap substantially all of the free radicals generated by the present processes. Effective amounts of exogenous (i.e., added) capping agents are used in the present processes, such as 1-1.5 moles of capping agent (e.g., hydrogen) may be used per mole of sulfur, nitrogen, or oxygen present. It is within the skill of the art to determine an effective amount of exogenous capping agent needed to carry out the present processes for the particular hydrocarbon feedstock being used based on the disclosure herein. The exogenous capping agent may include hydrogen, hydrogen sulfide, natural gas, methane, ethane, propane, butane, pentane, ethene, propene, butene, pentene, dienes, isomers of the forgoing, or a mixture of any two or more thereof. In any embodiments, the exogenous capping agent may be hydrogen and/or a C₁₋₆ acyclic alkanes and/or C₂₋₆ acyclic alkene or a mixture of any two or more thereof.

As the contacting step takes place at a temperature of about 250° C. to about 500° C., the sodium metal will be in a molten (i.e., liquid) state. For example, the contacting step may be carried out at about 250° C., about 275° C., about 300° C., about 325° C., about 350° C., about 375° C., about 400° C., about 425° C., about 450° C., about 500° C., or a range between and including any two of the foregoing temperatures. Thus, in any embodiments the contacting may take place at about 275° C. to about 425° C., or about 300° C. to about 400° C. (e.g., at about 350° C.).

In any embodiments, the contacting step may take place at a pressure of about 400 to about 3000 psi, e.g., at about 400 psi, about 500 psi, about 600 psi, about 750 psi, about 1000 psi, about 1250 psi, about 1500 psi, about 2000 psi, about 2500 psi, about 3000 psi or a range between and including any two of the foregoing values, e.g., a pressure of about 500 psi to about 3000 psi.

The reaction of sodium metal with heteroatom contaminants in the hydrocarbon/residual feedstocks is relatively fast, being complete within a few minutes. Mixing the combination of feedstock and metallic sodium further speeds the reaction and is commonly used for this reaction on the industrial scale. However, certain embodiments may require an extended residence time to improve the extent of conversion or adjust the operating conditions to target removal of a specific heteroatom impurity. Hence, in any embodiments the contacting step is carried out for about 1 minute to about 120 minutes, e.g., about 1, about 5, about 7, about 9, about 10, about 15 minutes, about 30, about 45 about 60, about 75, about 90, about 105, or about 120 minutes, or is conducted for a time ranging between and including any two of the foregoing values. Thus, in any embodiments the time may range from about 1 to about 60 minutes, about 5 minutes to about 60 minutes, about 1 to about 15 minutes, about 60 minutes to 120 minutes, or the like.

In any embodiments of the present process, it may be necessary to dilute the hydrocarbon feedstock with a diluent if an elevated asphaltene content in the hydrocarbon feedstock leads to a viscosity that is too high for the sodium treatment process. Because of the aromatic nature of asphaltenes, a diluent will typically include aromatics. This diluent may be a single compound e.g., benzene, toluene, xylene, trimethylbenzene (e.g., 1,2,3-trimethylbenzene, 1,2,4-trimethylbenzene, 1,3,5-trimethylbenzene, etc.), ethylbenzene, cumene, naphthalene, methylnaphthalene, (e.g., 1-methylnaphthalene or other isomers thereof), mixtures of any two or more thereof, or a refinery intermediate that is aromatic (e.g., light cycle oil, heavy cycle oil, reformate). The amount of diluent needed will vary with the asphaltene content of the feedstock and the viscosity required for processing. Higher asphaltene content in a feedstock may require more diluent than a feedstock with lower asphaltene content. It is within the skill in the art to select an appropriate amount of diluent to permit processing of asphaltenes in the present processes.

Removal efficiency of the sulfur content (a.k.a., conversion efficiency) from the hydrocarbon feedstock compared to the converted feedstock may be at least 40%, at least 50%, at least 60%, at least 70%, at least 80%, at least 90%, at least 95%, at least 96%, at least 97%, at least 98%, at least 99% or 100% by weight, or a range between and including any two of the foregoing values, e.g., from 40% to 99%, or from 40% to 95%. Where the effective amount of sodium metal is greater than a stoichiometric amount, the sulfur content conversion efficiency can be very high, e.g., at least 90%.

The fiber feedstock of the present technology typically contain less than wt % sulfur, e.g., less than 0.75 wt % sulfur, or even less than 0.5 wt % sulfur. In any embodiments, the fiber feedstock may have 0.01 wt % sulfur to less than 1 wt % sulfur, or less than 0.75 wt % sulfur, less than 0.5 wt % sulfur, or even less than 0.3 wt % sulfur. For example, the fibers may have 0.01 wt %, 0.02 wt %, 0.03 wt %, 0.04 wt %, 0.05 wt %, 0.075 wt %, 0.1 wt %, 0.15 wt %, 0.2 wt %, 0.25 wt %, 0.3 wt %, 0.4 wt % 0.5 wt %, 0.75 wt % or less than 1 wt % sulfur, or a range between and including any two of the foregoing values.

The fiber feedstocks of the present technology have a reduced concentration of metals compared to the hydrocarbon feedstocks. The metals content of the fiber feedstock may be reduced by at least 20% compared to the hydrocarbon feedstock, for example, by 20% to 100%. Examples of the percent reduction in metals (collectively or individually) in the converted feedstock compared to the hydrocarbon feedstock include 20%, 30%, 40%, 50%, 60%, 70%, 80%, 90%, 95%, 97%, 98%, 99%, 100%, or a range between and including any two or more of the foregoing values. Thus, in any embodiments the percent reduction may be from 20% to 99%, from 20% to 95%, from 70% to 99% or to 100%. The metals may be any of those disclosed herein. In some embodiments, the metals are selected from iron, vanadium, nickel or combinations of any two or more thereof. For example, the vanadium content of the converted feedstock has been reduced by at least 20% compared to the hydrocarbon feedstock or residual feedstock. Similarly, in any embodiments, the nickel content of the converted feedstock has been reduced by at least 20% compared to the hydrocarbon feedstock or residual feedstock.

The present methods may also include pretreating a hydrocarbon feedstock containing impurities prior to contacting with sodium metal. In some cases, a hydrocarbon feedstock may be pretreated to concentrate the impurities in a residual feedstock which is then used to prepare the fibers of the present technology. For example, a virgin crude oil may be distilled to produce one or more light distillate cuts (e.g., a purified feedstock that may be used for other purposes) and an atmospheric residuum (the residual feedstock) with a higher sulfur content and higher asphaltene content than that in both the purified feedstock and the virgin crude (i.e., the hydrocarbon feedstock). Alternatively, a hydrocarbon feedstock may be pre-treated to remove a portion of the undesired impurities to provide for a purified hydrocarbon feedstock with a lower concentration of impurities but which still meets the asphaltene and at least one of the sulfur and metals specifications for hydrocarbon feedstocks herein that are to be treated with sodium or sodium alloy in accordance with the present processes. The pre-treatment process may comprise a separation process, or a treatment process, or combinations of any two or more thereof.

In any embodiments, the pretreatment process may include a separation process that comprises one or more of a physical separation using energy (heat), phase addition (solvent or absorbent), a change in pressure, or application of an external field or gradient to concentrate the impurity in the residual feedstock. The separation process may include gravity separation, flash vaporization, distillation, condensation, drying, liquid-liquid extraction, stripping, absorption, centrifugation, electrostatic separation and their variants. The separation process may further comprise solvent extraction processes, including solvent deasphalting processes, such as Residuum Oil Supercritical Extraction (ROSE®). For example, a hydrocarbon feedstock may be desalted to remove salt and water, an API separator may be used to separate water and solids from oil or a distillation column may be used to separate low sulfur, low boiling point products from high sulfur, high boiling point products in crude oil. The separation process may also require a solid agent or barrier, such as adsorption, filtration, osmosis or their variants. Each of the disclosed separation processes results in a purified feedstock with a lower concentration of impurities than the hydrocarbon feedstock and a residual feedstock with a higher concentration of impurities than the purified feedstock. In any embodiments, the residual feedstock comprises impurities at a higher concentration than in the hydrocarbon feedstock. In any embodiments, the pretreatment process further provides a gaseous impurities stream (e.g., H₂S, water, NH₃ and light hydrocarbon gases such as methane, ethane and propane). Such gaseous impurities may be removed using an absorption process, sulfur recovery process, or other processes known in the art.

Processes of the present technology produces a mixture that includes the converted feedstock (or fiber feedstock) and sodium salts. The present processes may further include separating the sodium salts from the converted/fiber feedstock. The sodium salts are comprised of particles, which can be quite fine (e.g., <10 μm) and cannot be completely removed by standard separation techniques (e.g., filtration or centrifugation). In any embodiments, the separation may include heating the mixture of sodium salts and converted/fiber feedstock with elemental sulfur to a temperature from about 150° C. to 500° C. to provide a sulfur-treated mixture comprising agglomerated sodium salts; and separating the agglomerated sodium salts from the sulfur treated mixture, to provide the desulfurized converted/fiber feedstock and separated sodium salts. This separation may be carried out by any suitable method (e.g., centrifugation, filtration) as described in U.S. Pat. No. 10,435,631, the entire contents of which are incorporated by reference herein for all purposes.

Depending on the nature of the desulfurized converted/fiber feedstock, there may be considerable alkali metal content remaining, e.g., up to and sometimes exceeding 1% by weight. In some embodiments, such residual alkali metal is present at a level of about 400 ppm to about 10,000 ppm, e.g., about 400, about 600, about 800, about 1,000, about 1,200, about 1,400, about 1,600, about 2000, about 2,500, about 3,000 about 4,000, about 5,000, about 7,500 or even about 10,000 ppm or in a range between and including any two of the foregoing values. Some of the alkali metal content may be associated ionically at the sites where heavy metals originally held position or ionically associated with naphthenates, or finely dispersed in the metallic state, or ionically associated with sulfur, oxygen, or nitrogen which is still bonded to the organic molecules of the oil.

Removal of the residual alkali metal from the converted/fiber feedstock is required because the alkali metal content must be low to ultimately provide high quality carbon fiber. Also if a substantial amount of alkali metal were to leave the system; a large amount of make-up would be required to sustain the process. Hence, where the converted feedstock comprises unreacted sodium metal, the method may further comprise substantially removing the unreacted sodium metal from the converted feedstock. By “substantially removing” is meant removing the majority of the sodium, e.g., at least 90 wt %, at least 95 wt %, at least 98 wt %, or at least 99 wt % of the sodium.

Hence, in another aspect the present technology provides a demetallizing process which includes adding a salt-forming substance to the desulfurized converted/fiber feedstock to form a second mixture, wherein the salt-forming substance converts the residual alkali metal to an alkali metal salt. Any suitable salt-forming substance may be used so long as the resulting salt is readily removed from the converted/fiber feedstock. In some embodiments, the salt-forming substance can be selected from the group consisting of elemental sulfur, hydrogen sulfide, formic acid, acetic acid, propanoic acid and water. In some embodiments, acetic acid is used to form sodium acetate salts, which are relatively easy to remove in their solid form. Typically, the amount of salt-forming substance added is equal to about 1 to about 4 times the molar amount of residual alkali metal, e.g., 1, 1.25, 1.5, 2, 2.5, 3, 3.5 mole equivalents or a range between and including any two of the foregoing values. For example, in some embodiments, the amount is equal to about 1 to about 2 mole equivalents.

In some embodiments, the addition of salt-forming substance may be carried out at a temperature of at least 150° C., e.g., a temperature of about 150° C., about 200° C., about 250° C., about 300° C., about 351° C., about 400° C., about 450° C., or within a range between and including any two of the foregoing values. In some embodiments, the addition of salt-forming substance may be carried out at a temperature of about 150° C. to about 450° C.

In certain embodiments, the addition of salt-forming substance is carried out at a pressure of at least about 15 psi. In some embodiments the addition of salt-forming substance is carried out at a pressure of about 15 psi, about 25 psi, about 50 psi, about 100 psi, about 150 psi, about 200 psi, about 250 psi, about 300 psi, about 400 psi, about 500 psi, about 1,000 psi, about 1,500 psi, about 2,000 psi, about 2,500 psi or at a pressure in a range between and including any two of the foregoing values. For example, in some embodiments, the addition is carried out at about 50 psi to about 2,500 psi.

The demetallization process may include separating the alkali metal salts from the second mixture to provide a desulfurized and demetallized converted liber feedstock. For example, separating the alkali metal salts from the second mixture may include filtering, settling, or centrifuging the second mixture to remove the alkali metal salts and provide the desulfurized and converted/fiber feedstock.

The converted feedstock may also include light hydrocarbons, i.e., any lower molecular weight hydrocarbons that cause the softening point of the converted feedstock to be less than 200° C. For example, the light hydrocarbons may include light gas oil and lighter hydrocarbons. In some embodiments, the light hydrocarbons may even include some heavy gas oil as well as light gas oil and lighter hydrocarbons. Where the converted feedstock includes light hydrocarbons, the method may further include isolating the fiber feedstock from the converted feedstock. In some embodiments, this includes raising the softening point of the converted feedstock to at least 200° C., to at least 225° C., to at least 250° C., or at least 275° C., by removing at least a portion of the light hydrocarbons to provide the fiber feedstock. In any embodiments of the methods, removing the light hydrocarbons may include distilling the light fractions from the converted feedstock to provide the fiber feedstock. Distilling the light hydrocarbons may be carried out by, e.g., atmospheric pressure distillation, vacuum distillation, or a combination thereof. In any embodiments, light hydrocarbons up to and including light gas oil are removed, e.g., those with a boiling point up to 343° C.

Similarly, where the converted feedstock includes aromatic solvents used to dilute the asphaltenes as described herein, the fiber feedstock may be isolated by distilling the aromatic solvent from the converted feedstock to provide the fiber feedstock. Alternatively, the aromatic solvent and at least a portion of the light hydrocarbons may be distilled from the converted feedstock to provide the fiber feedstock.

The fiber feedstock may also be isolated from the converted feedstock by diluting the converted feedstock with a C₃₋₈ hydrocarbon or a mixture of any two or more thereof to precipitate asphaltenes and collecting the precipitated asphaltenes to provide the fiber feedstock.

The present processes may further include recovering metallic sodium from the separated sodium salts. In any embodiments, the present processes may further include electrolyzing the separated sodium salts to provide sodium metal. The separated sodium salts may comprise one or more of sodium sulfide, sodium hydrosulfide, or sodium polysulfide. The electrolyzing may be carried out in an electrochemical cell in accordance with, e.g., U.S. Pat. No. 8,088,270, or U.S. Provisional Patent Application No. 62/985,287, the entire contents of each of which are incorporated by reference herein for all purposes. The electrochemical cell may include an anolyte compartment, a catholyte compartment, and a NaSICON membrane that separates the anolyte compartment from the catholyte compartment. A cathode comprising sodium metal is disposed in a catholyte in the catholyte compartment. An anode comprising the sodium salts are disposed in anolyte in the anolyte compartment. An electrical power supply is electrically connected to the anode and cathode. In any embodiments, the separated sodium salts are dissolved in an organic solvent prior to electrolyzing the salts to provide sodium metal.

Illustrative embodiments of processes of the present technology will now be described. In one illustrative embodiment of the present technology, a hydrocarbon feedstock, typically having an asphaltene content of at least 30 wt % and containing sulfur and total metals impurities as described herein (e.g., a sulfur content of at least 1 or at least 0.75 wt %, or the like and total metals of at least 0.02 wt %, at least 0.05 wt %, or the like), is charged to a reactor (continuous or batch) along with effective amounts of sodium metal and an exogenous capping agent as described herein. Optionally, a solvent such as an aromatic solvent may be mixed with the hydrocarbon feedstock if the hydrocarbon feedstock is to viscous to conveniently flow at the temperatures being used. In some embodiments of the present processes, the hydrocarbon feedstock is a residual feedstock. That is, a first hydrocarbon feed is processed to remove lighter hydrocarbons, leaving the resulting residual feedstock enriched in asphaltene content to at least 30 wt %. The lighter hydrocarbons, which are purified relative to the first hydrocarbon feed, may be processed into other products, such as fuels.

The sodium reaction may be carried out at elevated temperature and pressure as described herein and is typically complete within minutes to give a mixture (“first mixture”) of sodium salts and converted feedstock. The converted feedstock includes a hydrocarbon oil with a sulfur content less than that in the hydrocarbon feedstock. To the extent that the converted feedstock has an asphaltene content less than 30 wt %, because, e.g., it started out that way or was mixed with a solvent, the converted feedstock will require further processing to ensure the fiber feedstock includes the minimum amount of at least 30% asphaltenes.

Optionally, the first mixture (of sodium salts and converted feedstock) is transported from the reactor to a second vessel where the sodium salts are agglomerated to particles large enough to be easily separated from the converted feedstock. Although any suitable agglomeration method may be used, agglomeration with elemental sulfur at elevated temperature as described herein may be used. The resulting mixture (“second mixture”) of agglomerated sodium salts, metals and converted feedstock may then be separated by any suitable process and device, such as by a centrifuge, to give the converted feedstock, free of precipitated metals, and sodium salts. Where the converted feedstock includes less than 30 wt % asphaltenes or has a softening point below 200° C., the process will include separating light hydrocarbons from the converted feedstock to raise the softening point above 200° C. (or even higher) and provide the fiber feedstock. Optionally, as described herein, the sodium salts may be subjected to electrolysis in an electrolytic cell with a sodium ion-selective ceramic membrane such as a NaSiCON membrane to provide sodium metal and elemental sulfur. The sodium metal and elemental sulfur may be reused in the present process.

### EXAMPLES

### Example 1—Preparation of Fibers from High-Asphaltene Feedstock (Vacuum Residue)

A series of six desulfurization runs were performed, each reacting 500 g of vacuum residue with 52.7 g of elemental sodium at 370° C. and 750 psig of hydrogen for a period of 60 minutes. To remove excess sodium, 8.4 g of sulfur were added and the mixture held with agitation at 350° C. and 300 psig for a period of 120 min. The reactor contents were centrifuged and the supernatant layers collected. Pairs of these layers were collected and analyzed for residual sodium content. These were 3640 ppm, 4267 ppm, and 4000 ppm respectively. The samples were then reacted at 300° C. and 300 psig with acetic acid in 15% excess to remove the sodium. The samples were centrifuged to remove the sodium acetate formed in the reaction.

The samples of desulfurized vacuum bottoms were then treated with a 10:1 w/w ratio of n-pentane, resulting in a significant fraction of the asphaltenes in the mixtures precipitating out of solution. The mixtures were centrifuged, the collected asphaltenes washed with an approximately 1:1 w/w ratio of n-pentane, recentrifuged, and the asphaltenes collected. A total of 133 g of asphaltenes were collected. The amounts of sulfur and metals in the asphaltenes compared to the vacuum residue feed are given in Table 1.

TABLE 1

| | Feed (Vacuum | Product |
|---|---|---|
| Impurities | Residue) | (Asphaltenes) |
| Sulfur (% w/w) | 6.1 | 0.69 |
| Vanadium (ppm) | 327 | 150 |
| Nickel (ppm) | 132 | 265 |

These asphaltenes were then melt spun and successfully formed fibers of 10 micron diameter. Stabilization (in the presence of oxygen) and carbonization (in the absence of oxygen) of the fibers up to a temperature of 1000° C. was undertaken. Tensile strength of the fibers was measured at 0.8 GPa, modulus was measured as 33 GPa.

### Example 2A—Preparation of Fibers from High-Asphaltene Feedstock

A series of six desulfurization runs was performed, each consisting of a 300 g sample having 89.7% asphaltenes, were mixed with 200 g of 1-methylnaphthalene to dissolve the asphaltenes. 35.5 g of sodium was added to the mixture and heated to 350° C. at a pressure of 750 psig of hydrogen with agitation. The mixture was allowed to react for 60 minutes. To remove excess sodium, 8.9 g of sulfur was added and the mixture held at 350° C. and 300 psig with agitation for 120 minutes. Following centrifugation to remove sodium sulfide crystals, key results for the product are presented in Table 2.

TABLE 2

| Impurities | Feed | Product |
|---|---|---|
| Sulfur (% w/w) | 6.6 | 1.3 |
| Vanadium (ppm) | 851 | 474 |
| Nickel (ppm) | 336 | 331 |

The resulting converted feedstock was vacuum distilled to an atmospheric equivalent temperature of 250° C. to remove the 1-methylnaphthalene fraction.

The distilled converted feedstock was then melt spun and successfully formed fibers of 12 micron diameter having 78.6% asphaltenes. Stabilization and carbonization of the fibers (i.e., graphitization) up to a temperature of 1000° C. was undertaken. Tensile strength of the fibers was measured at 1.0 GPa, modulus was measured as 32 GPa.

### Example 2B—Preparation of Fibers from High-Asphaltene Feedstock

A 375 g sample of asphaltenes (66.42% C7A, 82.66% C5A) was mixed with 125 g of 1,2,4-trimethylbenzene to dissolve the asphaltenes. Sodium (51.1 g) was added to the mixture and heated to 370° C. at a pressure of 750 psig of hydrogen with agitation. The mixture was allowed to react for 30 minutes. To remove excess sodium, 8.5 g of sulfur was added and the mixture held at 350° C. and 300 psig with agitation for 120 minutes. Following centrifugation to remove sodium sulfide crystals, key results for the converted feedstock product are presented in Table 3.

TABLE 3

| | Feed | Product |
|---|---|---|
| Sulfur (% w/w) | 7.6 | 0.65 |
| Vanadium (ppm) | 851 | 100 |
| Nickel (ppm) | 336 | 73 |

The resulting converted feedstock is distilled to remove the 524° C.− fraction. The remaining 524° C.+ fraction (fiber feedstock) will have a softening point greater than 200° C. Melt-spinning (to provide the asphaltene-containing fiber), stabilization, and graphitization is carried out as in Example 1 to provide the carbon fiber

### Example 3—Preparation of Fibers from High-Asphaltene Feedstock (from Bitumen)

A solid asphaltene feedstock was produced by treating bitumen with a sufficient quantity of n-pentane. 350 g of asphaltenes were then mixed with 350 g of mineral oil and treated with sodium at 350° C. and 1500 psig. Key results are summarized in Table 4. The results from Table 4 clearly indicate that molten sodium metal effectively removes impurities and improves the physical properties of asphaltenes. Sulfur content was reduced by 97.4%, the 524° C. cut was reduced by over 48% and metals were reduced by >97%.

TABLE 4
Key results for desulfurization of asphaltenes with sodium

| Feedstock | Asphaltenes | | |
|---|---|---|---|
| Reaction Conditions | | | |
| Temperature (° C.) | | 358 | |
| Pressure (psig) | | 1500 | |
| Sodium/Sulfur Molar ratio | | 1.07 | |
| Residence Time | | 60 | |
| | Feed | | Product |
| Physical Properties | | | |
| Sulfur (wt %) | 8.2% | | 0.2% |
| API Gravity | −11 | | 13 |
| Resid Cut (524 + ° C.) | 90.5% | | 46.8% |
| C7 Asphaltenes (wt %) | 64.9% | | |
| MCRT (wt %) | | | 12% |
| Vanadium (ppm) | 675 | | 5 |
| Nickel (ppm) | 201 | | 18 |
| Total Metals (ppm) | 926 | | 23 |
| Conversion Efficiency | | | |
| Sulfur (wt %) | | | 97.2% |
| Total Metals (ppm) | | | 97.5% |
| Resid Cut (524 + ° C.) | | | 48.3% |
| Product Quality Improvement | | | |
| API Gravity (per wt % S removed) | | | 3.00 |

The resulting converted feedstock is distilled to remove the 524° C.− fraction. The remaining 524° C.+ fraction (fiber feedstock) will have a softening point greater than 200° C. Melt-spinning (to provide the asphaltene-containing fiber), stabilization, and graphitization is carried out as in Example 1 to provide the carbon fiber.

### EQUIVALENTS

While certain embodiments have been illustrated and described, a person with ordinary skill in the art, after reading the foregoing specification, can affect changes, substitutions of equivalents and other types of alterations to the processes of the present technology and products thereof as set forth herein. Each aspect and embodiment described above can also have included or incorporated therewith such variations or aspects as disclosed in regard to any or all of the other aspects and embodiments.

The present technology is also not to be limited in terms of the particular aspects described herein, which are intended as single illustrations of individual aspects of the present technology. Many modifications and variations of this present technology can be made without departing from its spirit and scope, as will be apparent to those skilled in the art. Functionally equivalent methods within the scope of the present technology, in addition to those enumerated herein, will be apparent to those skilled in the art from the foregoing descriptions. Such modifications and variations are intended to fall within the scope of the appended claims. It is to be understood that this present technology is not limited to particular methods, feedstocks, compositions, or conditions, which can, of course, vary. It is also to be understood that the terminology used herein is for the purpose of describing particular aspects only, and is not intended to be limiting. Thus, it is intended that the specification be considered as exemplary only with the breadth, scope and spirit of the present technology indicated only by the appended claims, definitions therein and any equivalents thereof.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Likewise, the use of the terms “comprising,” “including,” “containing,” etc. shall be understood to disclose embodiments using the terms “consisting essentially of” and “consisting of.” The phrase “consisting essentially of” will be understood to include those elements specifically recited and those additional elements that do not materially affect the basic and novel characteristics of the claimed technology. The phrase “consisting of” excludes any element not specified.

In addition, where features or aspects of the disclosure are described in terms of Markush groups, those skilled in the art will recognize that the disclosure is also thereby described in terms of any individual member or subgroup of members of the Markush group. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents (for example, journals, articles and/or textbooks) referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims, along with the full scope of equivalents to which such claims are entitled.

1. A fiber comprising at least 30 wt % asphaltenes, less than 1 wt % sulfur and less than 0.1% of total metals based on the weight of the fiber.

2. The fiber of claim 1 comprising 30 to 100 wt % asphaltenes.

3. The fiber of claim 1 comprising at least 60 wt % asphaltenes.

4. The fiber of claim 1 comprising 0.01 wt % sulfur to less than 1 wt % sulfur.

5. The fiber of claim 1 comprising less than 0.75 wt % sulfur.

6. The fiber of claim 1 comprising 0.00001 wt % to less than 0.1 wt % total metals.

7. The fiber of claim 1 comprising 0.001 wt % to less than 0.05 wt % total metals.

8. The fiber of claim 1, wherein the total metals comprise at least one metal selected from the group consisting alkali metals, alkali earth metals, transition metals, post transition metals, and metalloids having an atomic weight equal to or less than 82.

9. The fiber of claim 1, wherein the total metals comprise at least one of vanadium, nickel, iron, arsenic, lead, cadmium, copper, zinc, chromium, molybdenum, silicon, calcium, sodium, potassium, aluminum, magnesium, manganese, titanium, or mercury.

10. The fiber of claim 1, wherein the fiber has a diameter from 1 um to 20 um.

11. The fiber of claim 1, wherein the fiber has a diameter from 2 um to 16 um.

12. The fiber of claim 1, wherein the fiber has a diameter from 5 um to 15 um.

13. A method of making a fiber comprising melt-spinning a fiber feedstock into a fiber of claim 1, wherein the fiber feedstock comprises at least 30 wt % asphaltenes, a sulfur content of less than 1 wt % and a total metals content of less than 0.1 wt %.

14. The method of claim 13, further comprising:
contacting a hydrocarbon feedstock with an effective amount of sodium metal and an effective amount of exogenous capping agent at a temperature of 250-500° C., to produce a mixture of sodium salts and a converted feedstock, wherein
the hydrocarbon feedstock comprises at least 1 wt % asphaltenes, a sulfur content of at least 1 wt % and a total metals content of at least 0.1 wt %; and
the converted feedstock comprises at least 30 wt % asphaltenes, optionally light hydrocarbons, a sulfur content of less than 1 wt %, and a total metals content of less than 0.1 wt %.

15. The method of claim 13, further comprising separating the sodium salts from the converted feedstock.

16. The method of claim 14, wherein the converted feedstock comprises unreacted sodium metal and the method further comprises substantially removing the unreacted sodium metal from the converted feedstock.

17. The method of claim 14 further comprising isolating the fiber feedstock from the converted feedstock.

18. The method of claim 15, further comprising raising the softening point of the converted feedstock to at least 200° C. by removing at least a portion of the light hydrocarbons to provide the fiber feedstock.

19. The method of claim 18 further comprising raising the softening point of the converted feedstock to at least 250° C. by removing at least a portion of the light hydrocarbons to provide the fiber feedstock.

20. The method of claim 14, wherein the hydrocarbon feedstock is diluted with an aromatic solvent.

21. The method of claim 20, wherein the aromatic solvent is selected from the group consisting of 1-methylnaphthalene, trimethylbenzene, benzene, toluene, xylene, ethylbenzene, cumene, naphthalene, an aromatic refinery intermediate, and a mixture of any two or more thereof.

22. The method of claim 20, further comprising isolating the fiber feedstock from the converted feedstock, wherein isolating the fiber feedstock comprises distilling the aromatic solvent from the converted feedstock to provide the fiber feedstock.

23. The method of claim 22, wherein the isolating step comprises diluting the converted feedstock with a C₃₋₈ hydrocarbon or a mixture of any two or more thereof to precipitate asphaltenes and collecting the precipitated asphaltenes to provide the fiber feedstock.

24. The method of claim 13, wherein the sulfur content of the hydrocarbon feedstock ranges from 1 wt % to 15 wt %.

25. The method of claim 13, wherein the hydrocarbon feedstock comprises 30-100 wt % asphaltenes.

26. The method of claim 13, wherein the total metals content of the hydrocarbon feedstock is from 0.05 wt % to 1 wt %.

27. The method of claim 14, wherein the exogenous capping agent is hydrogen, hydrogen sulfide, natural gas, methane, ethane, propane, butane, pentane, ethene, propene, butene, pentene, dienes, isomers of the forgoing or a mixture of any two or more thereof.

28. The method of claim 14, wherein the hydrocarbon feedstock is combined with sodium metal at a pressure of about 500 psig to about 3000 psig.

29. The method of claim 14, wherein the reaction of hydrocarbon feedstock with sodium metal occurs for a time from 1 minute to 120 minutes.

30. The method of claim 18, wherein removing light hydrocarbons comprises distilling light fractions from the converted feedstock to provide the fiber feedstock.

31. The method of claim 30, wherein distilling the light hydrocarbons is carried out by atmospheric pressure distillation, vacuum distillation, or a combination thereof.

32. The method of claim 13, wherein the melt-spinning is single-hole melt spinning.

33. The method of claim 13, further comprising oxidizing the fiber to produce an oxidized fiber.

34. The method of claim 33, wherein the fibers are oxidized by heating the fibers to 200-400° C. in air.

35. The method of claim 33, further comprising carbonizing the oxidized fiber to produce a carbon fiber.

36. The method of claim 35, wherein the carbonizing comprises heating the oxidized fiber to 1000°−2000° C. in an inert, oxygen-free atmosphere.

37. The method of claim 35 further comprising graphitizing the carbon fiber by heating the carbon fiber in an oxygen-free atmosphere above 2000° C. up to 3000° C.
